(19) United States
(12) Patent Application Publication
(10) Pub. No.: US 2024/0330403 A1
(43) Pub. Date: Oct. 3, 2024

(54) EMULATING RANDOMIZED CONTROLLED TRIALS USING GENERAL DATA

(71) Applicant: INTERNATIONAL BUSINESS MACHINES CORPORATION, Armonk, NY (US)

(72) Inventors: Yishai SHIMONI, Tel Aviv (IL); Liran SZLAK, Shoham (IL); Lucile TER-MINASSIAN, Yafo (IL); Ehud KARAVANI, Tel Aviv (IL); Yoav KAN-TOR, Tel Aviv (IL)

(21) Appl. No.: 18/129,468

(22) Filed: Mar. 31, 2023

(51) Int. Cl. G06F 17/18

(52) U.S. Cl. CPC G06F 17/18

(57) ABSTRACT

In one aspect of the invention, there is a computer-implemented method including: determining, by a processor set, for each of a plurality of covariates in subject data on a plurality of subjects, a statistical bias measure; selecting, by a processor set, one of the covariates based on the statistical bias measure; dividing, by a processor set, the subjects into two or more groups, based on the selected covariate, such that each of the groups has an enhanced uniformity in a probability of being assigned a same treatment in a hypothetical randomized controlled trial; recursively repeating, by the processor set, for each respective group of the groups, the applying a division of the subjects into two or more groups, until reaching a selected stopping criterion for the respective group; and deriving, by the processor set, observational results of one or more input factors of one or more of the groups.

### BACKGROUND

Aspects of the present invention relate generally to statistical modeling and, more particularly, to statistical modeling related to randomized controlled trials.

Randomized controlled trials are used to accurately determine outcomes of treatments or campaigns in settings such as medical, pharmaceutical, and epidemiological studies. Preparing for and conducting randomized controlled trials involves following various protocols and practices, such as randomly assigning members of a test population to receive either a candidate treatment or a placebo or alternative, which are designed to eliminate statistical bias from the research results.

The protocols and practices required for preparing for and conducting randomized controlled trials are onerous and expensive to administer and manage, and restrict the capability and speed of medical discovery. For example, a typical administrative approval process for a new pharmaceutical treatment, such as may be administered in the United States under the auspices of the Federal Drug Administration (FDA), may typically require an escalating set of increasingly large tiers of properly identified and then randomized populations to target for a potential treatment. This process may typically require many years and billions of dollars. Even then, a hitherto promising novel treatment that continues to show promise and advances through each of the initial, increasingly larger tiers of populations may be shown in the final, largest-scale tier to be ineffective or even countereffective after all, thereby scuttling many years of work by large teams and providing no return on investment of up to many billions of dollars. Such large-scale failures weigh on investment risk analysis and inhibit the investments necessary to perform randomized controlled trials to drive the process of discovery in medical and other fields. Further, the costs, burdens, and expected returns on investments of conducting randomized controlled trials have demonstrated a reverse Moore's Law and have tended to continue escalating over time.

### SUMMARY

There is thus a tremendous and general need for any prospective material advances in the process of yielding randomized controlled trial data for medical and epidemiological discovery and other fields involving population interventions, which this invention delivers. Aspects of the invention thus address general problems such as the need for more advances in medical knowledge and more treatments of greater efficacy and ease of delivery for all kinds of medical issues, and the inability to reliably derive discoveries of such novel discoveries and treatments from the much larger and more widely available datasets that are not derived from properly administered randomized controlled trials. Due to the explosion of data in the modern world relative to the ever-rising costs and burdens of conducting randomized controlled trials, there are many and ever-increasingly greater orders of magnitude of available datasets from sources outside of randomized controlled trials. In aspects of this disclosure, computer-implemented systems are enabled and configured to use some of those datasets that are not from randomized controlled trials but that contain enough information on covariates, input factors, and results over time, to perform post hoc reconstruction of group covariates that indicate a priori hypothetical likelihood of having been assigned a same treatment (or placebo) in a randomized controlled trial. In aspects of this disclosure, computer-implemented systems are thus configured to perform post hoc emulation of randomized controlled trials using datasets from the much greater world of more general data sources outside of those derived from randomized controlled trials. Further aspects of this disclosure are also directed to computer-implemented systems that apply these inventive features in medicine and epidemiology as well as a wide range of other fields of applications. In aspects of this disclosure, computer-implemented systems may thus function as novel general engines of discovery to unlock new troves of medical and epidemiological discoveries and knowledge of novel efficacious treatments.

In a first aspect of the invention, there is a computer-implemented method including: determining, by a processor set, for each of a plurality of covariates in subject data on a plurality of subjects, a statistical bias measure; selecting, by a processor set, one of the covariates based on the statistical bias measure; dividing, by a processor set, the subjects into two or more groups, based on the selected covariate, such that each of the groups has an enhanced uniformity in a probability of being assigned a same treatment in a hypothetical randomized controlled trial; recursively repeating, by the processor set, for each respective group of the groups, the applying a division of the subjects into two or more groups, until reaching a selected stopping criterion for the respective group; and deriving, by the processor set, observational results of one or more input factors of one or more of the groups.

In this manner, a processor set of this disclosure may identify groups from general datasets that are balanced in their covariates between groups, and have enhanced uniformity in a probability of having been assigned to a same treatment group if the data about them, and about observational results of one or more input factors, had been collected in a randomized controlled trial. The processor set may thereby emulate the results of having conducted a randomized controlled trial from general datasets, and derive observational results of the one or more input factors of one or more of the groups. Deriving, by the processor set, the observational results of the one or more input factors of the one or more of the groups may illustratively take the form of discovering new medical and therapeutic applications of one or more pharmaceuticals or lifestyle interventions.

In another aspect of the invention, there is a computer program product including one or more computer readable storage media having program instructions collectively stored on the one or more computer readable storage media. The program instructions are executable to: determine, for each of a plurality of covariates in subject data on a plurality of subjects, a statistical bias measure; select one of the covariates based on the statistical bias measure; divide the subjects into two or more groups, based on the selected covariate, such that each of the groups has an enhanced uniformity in a probability of being assigned a same treatment in a hypothetical randomized controlled trial; recursively repeat, for each respective group of the groups, the applying a division of the subjects into two or more groups, until reaching a selected stopping criterion for the respective group; and derive observational results of one or more input factors of one or more of the groups.

In this manner, a computer program product of this disclosure set may identify groups from general datasets that share commonalities by which they have balanced covariates between groups, such that each group has an enhanced uniformity in the probability of having been assigned to a same treatment group if the data about them, and about observational results of one or more input factors, had been collected in a randomized controlled trial. The computer program product may thereby emulate the results of having conducted a randomized controlled trial from general datasets, and derive observational results of the one or more input factors of one or more of the groups. Deriving, by the computer program product, the observational results of the one or more input factors of the one or more of the groups may illustratively take the form of discovering new medical and therapeutic applications of one or more pharmaceuticals or lifestyle interventions.

In another aspect of the invention, there is a system including a processor set, one or more computer readable storage media, and program instructions collectively stored on the one or more computer readable storage media. The program instructions are executable to: determine, for each of a plurality of covariates in subject data on a plurality of subjects, a statistical bias measure; select one of the covariates based on the statistical bias measure; divide the subjects into two or more groups, based on the selected covariate, such that each of the groups has an enhanced uniformity in a probability of being assigned a same treatment in a hypothetical randomized controlled trial; recursively repeat, for each respective group of the groups, the applying a division of the subjects into two or more groups, until reaching a selected stopping criterion for the respective group; and derive observational results of one or more input factors of one or more of the groups.

In this manner, a system of this disclosure may identify groups from general datasets that share commonalities by which they have balanced covariates between groups, and enhanced uniformity in a probability of having been assigned to a same treatment group if the data about them, and about observational results of one or more input factors, had been collected in a randomized controlled trial. The system may thereby emulate the results of having conducted a randomized controlled trial from general datasets, and derive observational results of the one or more input factors of one or more of the groups. Deriving, by the system, the observational results of the one or more input factors of the one or more of the groups may illustratively take the form of discovering new medical and therapeutic applications of one or more pharmaceuticals or lifestyle interventions.

In another aspect of the invention, the processor set determining the bias measure comprises determining an absolute standardized mean difference (ASMD). The ASMD may function as an excellent option for a bias measure, thereby facilitating dividing the data subjects in such a way to build from general datasets toward groups that emulate results from randomized controlled trials.

In another aspect of the invention, the processor set selecting a covariate based on the bias measure comprises the processor set electing a covariate determined to have the highest bias measure of any of the covariates. The processor set dividing data subjects into groups based on the covariate determined to have the highest bias measure of any of the covariates may function to help reduce and potentially eliminate sources of statistical bias from within the remaining groups and move them closer to populations that are free of statistically confounding sources of bias and that emulate populations that would have been selected for randomized controlled trials.

In another aspect of the invention, the processor set may further select a split value of the selected covariate, wherein dividing the subjects into two or more groups based on the selected covariate comprises dividing the subjects into two or more groups based on the split value of the selected covariate. The processor set selecting the split value of the selected covariate comprises the processor set determining a p-value for each of a plurality of threshold values of the selected covariate in the subject data, and selecting one of the threshold values that has a minimal p-value as the split value. The processor set determining a p-value for each of the plurality of threshold values of the selected covariate in the subject data and selecting a threshold value that has a minimal p-value may function to help reduce and potentially eliminate sources of statistical bias from within the remaining groups and move them closer to populations that are free of statistically confounding sources of bias and that emulate populations that would have been selected for randomized controlled trials. In the event that only one threshold value exists of the selected covariate, then there is no threshold value with a greater p-value, and selecting a threshold value using the minimal p-value comprises selecting the one threshold value, and using its p-value.

In another aspect of the invention, the processor set determining the p-value for each of the plurality of threshold values of the selected covariate in the subject data comprises the processor set using Fisher's exact test or using a chi-squared test. Using Fisher's exact test or using a chi-squared test may function as advantageous methods of determining the p-value for each of the plurality of threshold values of the selected covariate in the subject data.

In another aspect of the invention, the processor set may further correct the p-values, after reaching the selected stopping criterion, and prune a causal tree comprising the groups until all of a set of final groups of the causal tree result from a split with a statistically significant p-value. The processor set correcting the p-values after reaching the selected stopping criterion and pruning the causal tree comprising the groups until all of a set of final groups of the causal tree have a statistically significant p-value may function to enable and combine the advantages of using an independent stopping criterion in dividing the data subjects into groups with then enabling splitting into groups that result in no statistical bias, to yield insights into the derived observational results of the one or more input factors of the one or more of the groups, as would be the case in a properly designed and administered randomized controlled trial, ideally with statistically significant population sizes. The processor set correcting the p-values after reaching the selected stopping criterion and pruning the causal tree comprising the groups until all of a set of final groups of the causal tree the result from splits with a statistically significant p-value may thus function to further emulate a randomized controlled trial.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a flowchart of an exemplary method in accordance with aspects of the present invention.

### DETAILED DESCRIPTION

Aspects of the present invention relate generally to emulating randomized controlled trials, and gaining the research results and benefits of randomized controlled trials, using general observational data sets that were not generated using the required randomization and control protocols and processes of randomized controlled trials. Collecting general observational data sets on effects on populations of treatments, campaigns, or other interventions without adhering to the randomization and control protocols and processes required for randomized controlled trials is substantially less burdensome and less costly than performing randomized controlled trials. Data on effects of interventions on populations may also have been collected for a wide variety of purposes, without a prior intent of seeking randomized controlled data results. Consequently, for various applications, there tends to be large amounts of relevant data that are not due to randomized controlled trials, and that are thus relevant but are inherently affected by statistical biases. Because of the statistical biases, such data cannot be relied on accurately to represent balance in the covariate distribution between treatment groups, accurately to distinguish between correlation and causation, and accurately to demonstrate true statistical outcomes of treatments or campaigns in settings such as medical, pharmaceutical, and epidemiological studies, and marketing campaigns.

Inventive aspects of this disclosure transcend such conventional limitations of observational data collected outside of the realm of randomized controlled trials. Remarkably, inventive aspects of this disclosure enable processing data from general observational data sets to post hoc cleanse the data of the inherent statistical biases due to not having been generated with the proper randomization and control protocols and processes of randomized controlled trials. Inventive aspects of this disclosure enable post hoc transformation of such data collected in a wide array of general observational data gathering contexts into statistically unbiased results data, as if the data had been generated by way of randomized controlled trials.

In various embodiments, inventive aspects of this disclosure include computer-implemented systems and methods analyzing multidimensional data sets on treatments or other factors among populations, and identifying subject population segments that share commonalities and uniformities in their probability of being assigned the same treatment or intervention of any kind in a randomized controlled trial. Among the novel and inventive insights of this disclosure, by post hoc identifying population segments that have no statistical difference in their similarity of being assigned treatment in a randomized controlled trial, it is possible to analyze such datasets with post hoc emulation of the data having been generated in a randomized controlled trial, and to gain the benefits of having done so. Such benefits may include generating novel, accurate discoveries and insights on the effects of such treatments, medical factors, or interventions on the populations, and novel discoveries of pharmaceuticals or other treatments for efficacious treatment of conditions or for new superior medical outcomes, or deriving any other kind of observational results in general on one or more of the groups based on any kind of exogeneous and/or endogenous input factors in general that were applied to or observed in the groups, in illustrative examples.

By deriving observational results of one or more input factors of one or more of the groups resulting from the divisions into groups as described herein, the derived observational results emulate the results of a hypothetical randomized controlled trial in accordance with which the group divisions were made. The derived observational results of the groups may thus yield new discoveries, insights, efficacious medical and public health treatments, and other results as if the results were from a randomized controlled trial, even though they are derived from much more abundant and easily obtained datasets. Aspects of this invention thus address general problems such as the need for more advances in medical knowledge and more treatments of greater efficacy and case of delivery for all kinds of medical issues, and the inability to reliably derive discoveries of such novel discoveries and treatments from the much larger and more widely available datasets that are not derived from properly administered randomized controlled trials.

In various embodiments, inventive aspects of this disclosure thereby enable such generalized data to newly yield accurate, statistically significant results data on the effects of interventions or practices such as medical treatments or epidemiologically and medically relevant lifestyle practices on populations. Various inventive aspects of this disclosure may thereby further enable novel advantages such as unlocking new knowledge of medical treatments and medically relevant practices, and other novel medical discoveries and insights that may be used to improve medical outcomes and boost quality of life across populations, and save lives.

Various examples are directed to a computer-implemented method and system for a decision tree that identifies sub-population that represent a natural quasi-experiment. In an example method, a computing system may perform a step of defining each node of a decision tree as representing a sub-population. At each step, the computing system may determine a criterion to split the population using a single feature, and potentially several thresholds, attempting to create sub-populations with smaller statistical bias. The method may include a step wherein the computing system chooses a feature as having the highest absolute standard mean difference (“ASMD”), and choosing a single threshold to maximize the association with the treatment assignment (e.g., using Fisher's exact statistical test). The method may include a step of the computing system continuing to split the data until reaching a pre-defined stopping criterion. The method may include a step wherein there exists a set of default stopping criteria based on criteria illustratively including the size of the data, the number of treated and untreated, and the level of statistical bias. The computing system may provide a user interface enabling these criteria to be modified by user inputs.

Implementations of the invention are necessarily rooted in computer technology. For example, methods of this disclosure may be performed on sets of data including hundreds of thousands, millions, or billions of subjects, with data on a large number of covariates per subject, and each of which may be in long time series. Especially when regarded in contexts such as this, it is evident that steps of this disclosure such determining, for each of a plurality of covariates in subject data on a plurality of subjects, a statistical bias measure; selecting one of the covariates based on the statistical bias measure; dividing the subjects into two or more groups, based on the selected covariate, such that each of the resulting groups has an enhanced uniformity in the probability of being assigned the same treatment in a hypothetical randomized controlled trial; and recursively repeating, for each of the groups, the applying a division of the subjects into two or more groups, until reaching a selected stopping criterion, are computer-based and cannot be performed in the human mind. Performing such sophisticated statistical analysis on such large data sets may only feasibly be performed by a computer and cannot practically be performed in the human mind (or with pen and paper) due to the complexity and massive amounts of calculations involved. Given this scale and complexity, it is simply not possible for the human mind, or for a person using pen and paper, to perform the number of calculations involved in performing such sophisticated statistical analysis on such large data sets.

It should be understood that, to the extent implementations of the invention collect, store, or employ personal information provided by, or obtained from, individuals (for example, patients or subjects from whom medical treatment data are collected), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as randomized controlled trial (RCT) emulator code 200 (“RCT emulator code 200”). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

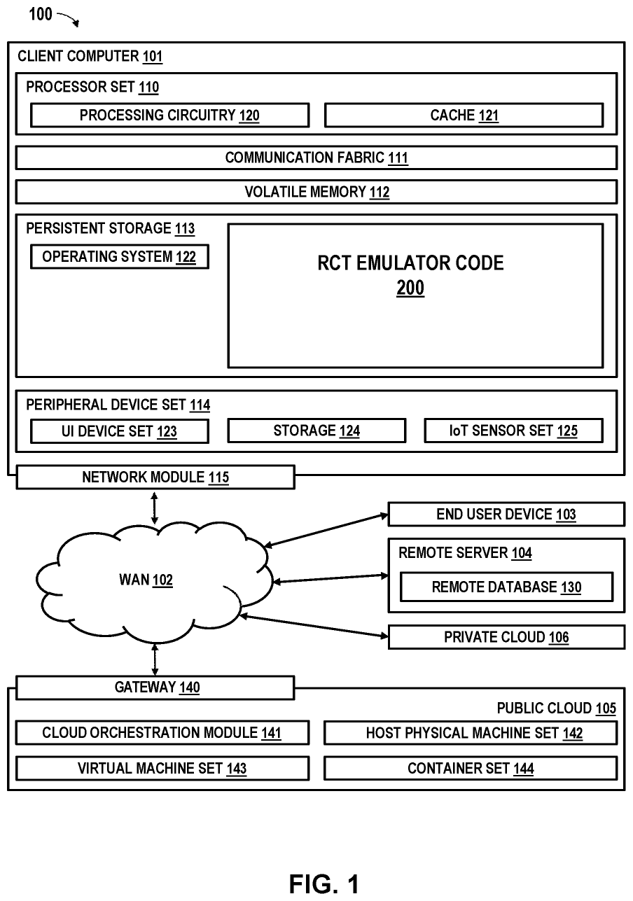

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

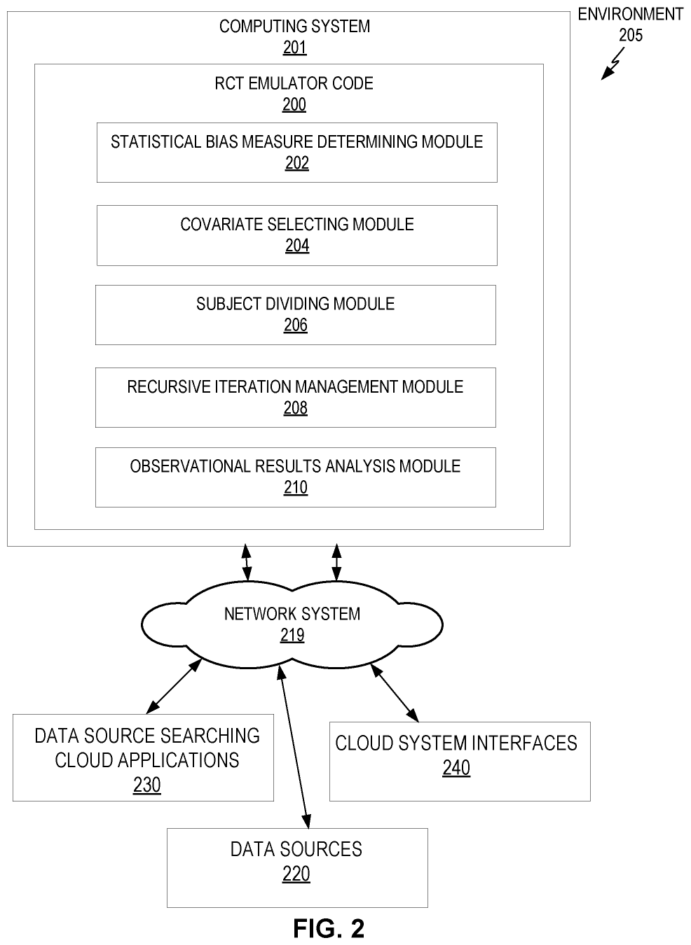

FIG. 2 shows a block diagram of an exemplary computing environment 205 in accordance with aspects of the invention. In embodiments, environment 205 includes computing system 201, which implements example randomized controlled trial (RCT) emulator code 200 (“RCT emulator code 200”), as introduced above with reference to FIG. 1. In various embodiments, RCT emulator code 200 of FIG. 2 comprises statistical bias measure determining module 202, covariate selecting module 204, subject dividing module 206, recursive iteration management module 208, and observational results analysis module 210. Each of modules 202, 204, 206, 208, and 210 may comprise modules of the code of block 200 of FIG. 1.

Such modules may include routines, programs, objects, components, logic, data structures, and so on that perform particular tasks or implement particular data types that the code of block 200 uses to carry out the functions and/or methodologies of embodiments of the invention as described herein. The term “module” here may refer to any portion or collection of software code in any form, and is not limited to any potential more restricted meaning of the term “module” that may be used in other contexts or technical domains. These modules of the code of block 200 are executable by the processing circuitry 120 of FIG. 1 to perform the inventive methods as described herein. RCT emulator code 200 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

Computing environment 205 also includes network system 219, data sources 220, data source searching cloud applications 230, and cloud system interfaces 240. In some examples, RCT emulator code 200 may be deployed to the cloud as a cloud application, may be configured to use data source searching cloud applications 230 to search arbitrarily large and widespread data sources 220, and may be provided and accessible to arbitrarily large numbers of users around the world as a cloud-hosted software application via cloud system interfaces 240.

Computing system 201 may be implemented in a variety of configurations for implementing, storing, running, and/or embodying RCT emulator code 200. Computing system 201 may comprise one or more instances of computer 101 of FIG. 1, in various examples. Data source searching cloud applications 230 and cloud system interfaces 240 may comprise or be comprised in one or more instances of client computer 101, remote server 104, private cloud 106, and public cloud 105 of FIG. 1, in various examples. RCT emulator code 200, data source searching cloud applications 230, and cloud system interfaces 240 may be separate, as shown in FIG. 2, in various examples, in which RCT emulator code 200 functions cooperatively with data source searching cloud applications 230 and cloud system interfaces 240. In various other examples, data source searching cloud applications 230 and cloud system interfaces 240 may be comprised as part of RCT emulator code 200.

Network system 219 may comprise one or more instances of WAN 102, remote server 104, private cloud 106, and public cloud 105 of FIG. 1, in various examples. Computing system 201 in various examples may comprise a cloud-deployed computing configuration, comprising processing devices, memory devices, and data storage devices dispersed across data centers of a regional or global cloud computing system, with various levels of networking connections, such that any or all of the data, code, and functions of RCT emulator code 200 may be distributed across this cloud computing environment. RCT emulator code 200, computing system 201, and/or environment 205 may thus constitute and/or be considered an RCT emulator code system, and may comprise and/or be constituted of one or more software systems, a combined hardware and software system, one or more hardware systems, components, or devices, one or more methods or processes, or other forms or embodiments.

In other examples, computing system 201 may comprise a single laptop computer, or a specialized statistical analysis workstation equipped with one or more graphics processing units (GPUs) and/or other specialized processing elements, or a collection of computers networked together in a local area network (LAN), or one or more server farms or data centers below the level of cloud deployment, or any of a wide variety of computing and processing system configurations, any of which may implement, store, run, and/or embody RCT emulator code 200. RCT emulator code 200 may interact via network system 219 with any other proximate or network-connected computing systems to collect and/or process subject data from data sources 230, in various examples.

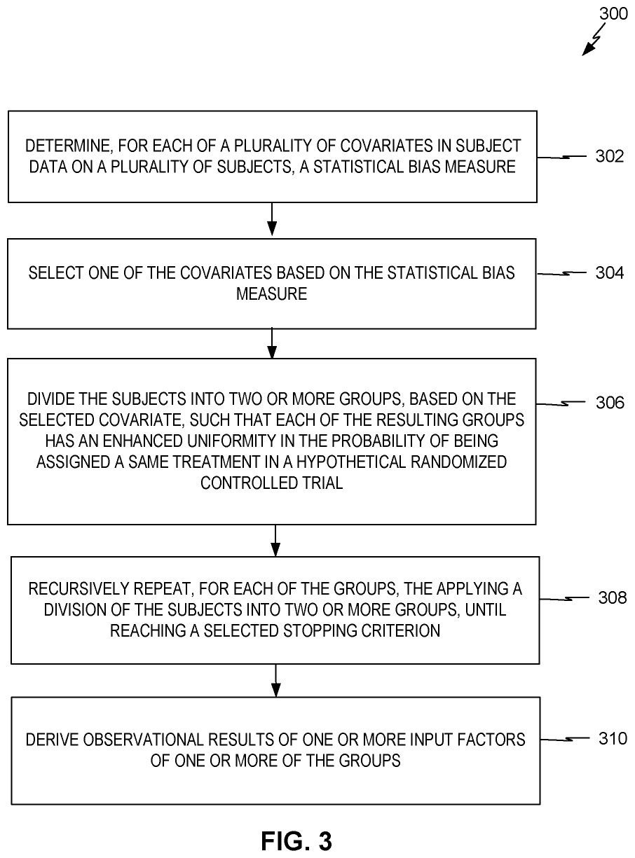

FIG. 3 shows a flowchart of an exemplary method in accordance with aspects of the present invention. Steps of the method may be carried out in the environment of FIG. 2 and are described with reference to elements depicted in FIG. 2. In method 300, RCT emulator code 200 (e.g., statistical bias measure determining module 202 thereof as shown in FIG. 2) determines, for each of a plurality of covariates in subject data on a plurality of subjects, a statistical bias measure (302). In various embodiments, and as described with respect to FIG. 2, RCT emulator code 200 (e.g., covariate selecting module 204 thereof as shown in FIG. 2) selects one of the covariates based on the statistical bias measure (304). In various embodiments, RCT emulator code 200 (e.g., subject dividing module 206 thereof as shown in FIG. 2) divides the subjects into two or more groups, based on the selected covariate, such that each of the groups has an enhanced uniformity in the probability of being assigned a same treatment in a hypothetical randomized controlled trial (306). In various embodiments, RCT emulator code 200 (e.g., recursive iteration management module 208 thereof as shown in FIG. 2) recursively repeats, for each of the groups, the applying a division of the subjects into two or more groups, until reaching a selected stopping criterion (308). In various embodiments, RCT emulator code 200 (e.g., observational results analysis module 210 thereof as shown in FIG. 2) derives observational results of one or more input factors of one or more of the groups (310).

RCT emulator code 200 may thus analyze a data set to determine what the effects or observational results are of a pharmaceutical treatment, lifestyle treatment (e.g., dietary, exercise, or sleep hygiene routine), other kind of intervention, or any other kind of input factor, with a population. The intervention or input factor may be of any of a wide variety of kinds in any of a wide variety of contexts, such as administering a pharmaceutical treatment, a new lifestyle intervention such as a novel exercise or dietary routine, or delivering a marketing campaign.

RCT emulator code 200 is configured to emulate and gain the analytical benefits of randomized controlled trials using general observational data sets, without regard to whether the data sets were prepared and conducted with and subject to randomized and controlled protocols. In various aspects, RCT emulator code 200 may identify population segments that share commonalities, not necessarily in their features or in their outcomes, but are similar in their probability of being assigned the same treatment in a real-world scenario. By post hoc identifying population segments that have no difference in their probability of being assigned treatment, it is possible to analyze the datasets with post hoc emulation of having conducting a randomized controlled trial, and to gain the accurate and statistically unbiased analysis of having done so.

In various aspects, RCT emulator code 200 may address and resolve lack of balance in the covariate distribution between subject groups from whom observational data are collected, such as treatment groups, where such lack of balance in the covariate distribution compromises the ability to draw accurate causal conclusions. In various aspects, RCT emulator code 200 may determine bias by determining a statistical bias measure, such as, e.g., absolute standard mean difference (“ASMD”), absolute standard bias, standard mean difference, or any suitable bias measure. In various aspects, RCT emulator code 200 may use causal inference to correct biases in the observational data and thereby emulate a randomized clinical trial.

In various aspects, RCT emulator code 200 may construct bias-balancing explainable causal trees, to recursively partition the multidimensional data to obtain bias-balanced sub-populations from which statistical biases are thereby cleansed, and from which RCT emulator code 200 may then obtain accurate causal inferences. In various aspects, RCT emulator code 200 may stratify the data subjects into subpopulations in which covariates are balanced, thereby enabling RCT emulator code 200 to draw valid causal effect estimations and propensity to treat estimations. In various aspects, RCT emulator code 200 applies inventive splitting criteria for dividing the subject data and constructing causal trees that have a bias-balanced subpopulation in each leaf of the causal tree. The leaves are the end nodes of the causal tree, corresponding to the smallest and final divisions of the data subjects into subpopulations in which the statistical biases of the original data collecting have been either eliminated, or reduced as much as usefully possible or feasible, in various examples.

RCT emulator code 200 may identify subject population segments that share commonalities or similarities in their probability of being assigned the same treatment or intervention of any kind in the settings in which the data was observed. RCT emulator code 200 may thereby construct a causal tree in which each leaf emulates a separate, independent randomized control trial.

In randomized control trials, groups are compared that receive different treatments in order to assess the causal effect of a treatment compared to a placebo or other treatment or other control. In this scenario, participants are randomized between the different treatment assignments, leading to balance in the distribution of attributes or covariates of the population in each group. However, in most observational datasets, such balance does not exist and thus the observed relations between intervention and outcome cannot be considered causal. This is due to biases that arise when one group is enriched in particular attributes compared to the other group (for instance, one group is enriched with females under the age of 40 whereas the other group is not). In order to compare the two groups in order to draw causal conclusions, it is necessary to balance the groups compared in terms of their attributes or covariates. RCT emulator code 200 enables removing such biases. RCT emulator code 200 further enables removing such biases in an explainable manner, leading to valid casual inference and propensity estimations, which are backed by understandable and mathematically established explanations.

RCT emulator code 200 uses a causal tree model in which RCT emulator code 200 selects features and thresholds that maximize a bias measure, such as the ASMD, between the two treatment groups, as splits or nodes in the causal tree. At each node of the causal tree, starting from the root of the causal tree, RCT emulator code 200 selects the feature which shows the highest lack of balance or the highest bias measure (e.g., the highest ASMD). At each node of the causal tree, RCT emulator code 200 then determines an advantageous threshold or thresholds to split the data into sub-groups. RCT emulator code 200 defines the sub-groups as children nodes of the current node. For example, RCT emulator code 200 may use Fisher's exact test and check that a corrected p-value is over a selected advantageous threshold to make a binary split, in determining a single threshold to define a division of the data from the parent node into two sub-groups. In another example, RCT emulator code 200 may use a piecewise-constant/sigmoid function fit to define multiple split values, in determining two or more thresholds to define a division of the data from the parent node into three or more sub-groups.

RCT emulator code 200 may continue to divide the subject data into smaller groups of subjects until RCT emulator code 200 reaches a stopping criterion for each respective group resulting from a split, or until RCT emulator code 200 reaches at least one of multiple stopping criteria, in various examples. As an example of a stopping criterion, RCT emulator code 200 may continue to divide the subject data in each respective group or sub-population created by the previous splits into smaller groups of subjects until RCT emulator code 200 reaches a minimum leaf size, or minimum number of data subjects assigned to at least one leaf of the causal tree. In other words, the selected stopping criterion comprises a minimum number of data subjects assigned to a most recently divided respective group of the groups, constituting the current set of leaves or most recently generated round of nodes of the causal tree. As another example of a stopping criterion for a respective group, RCT emulator code 200 may continue to divide the subject data into smaller groups of subjects until the respective group or node reaches a p-value does not pass a pre-defined threshold of p-value the maximum bias measure (e.g., maximum ASMD) in the respective group of subject data reaches some minimal threshold. The selected stopping criterion for the respective group may comprise determining, for a respective group or node of a most recently divided set of the groups, that there is no covariate and threshold value that has a p-value that passes a selected p-value threshold in the respective group. The selected stopping criterion for the respective group may comprise determining that the respective group of a most recently divided set of the groups has a maximum bias measure under a minimal threshold of maximum bias measure. Using such a stratification scheme, RCT emulator code 200 may reduce the bias within each subpopulation characterized by the trajectories of the data subject samples in the causal tree, until reaching an endpoint leaf with a stopping criterion for each remaining group. When a stopping criterion has been reached for each remaining group, no more splits are done, and the sets of subjects assigned to the leaves of the causal tree represent bias-balanced subpopulations, or groups of the data subjects from which the original statistical biases have been eliminated or optimally reduced.

In other examples, RCT emulator code 200 may build a causal tree disregarding the p-value stopping condition. In some examples, RCT emulator code 200 may first fully build a causal tree, and after the causal tree is fully built, RCT emulator code 200 may then prune the causal tree so that the final splits in the tree result in final groups or leaves that have a significant p-value.

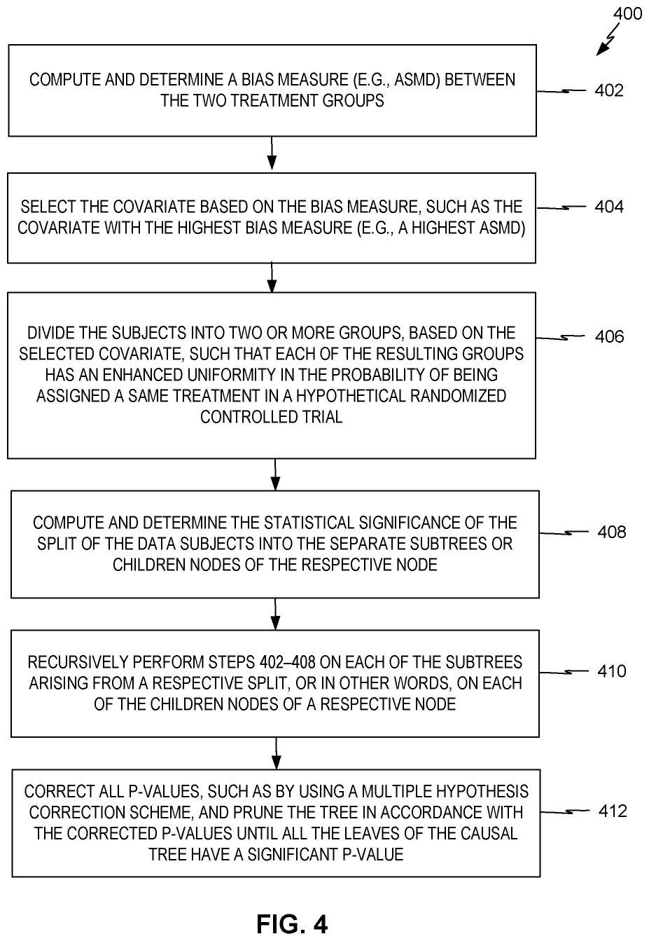

FIG. 4 depicts a flowchart for an example method 400 that RCT emulator code 200 may perform, in accordance with aspects of this disclosure. RCT emulator code 200 may start with a dataset X as the root of a causal tree, and perform the steps of method 400 recursively until reaching a stopping condition. For each of a plurality of covariates, or feature values, in subject data on a plurality of subjects, RCT emulator code 200 may compute and determine a bias measure (e.g., ASMD) between the two treatment groups (402). Step 402 is an example corresponding with step 302 of FIG. 3. RCT emulator code 200 may select the covariate based on the bias measure, such as the covariate with the highest bias measure (e.g., a highest ASMD) (404). Step 404 is an example corresponding with step 304 of FIG. 3. For selecting the covariate, or feature value, with the highest bias measure in a binary split, RCT emulator code 200 may analyze all of the covariates, compute and determine the p-value for each of the feature values (e.g., using Fisher's exact test, or using a chi-squared test), and select the feature value that has the minimal p-value, in various examples. RCT emulator code 200 may thereby identify the value for which the mean treatment prevalence differs the most on both sides of the subtree, and maximizes the association in treatment assignment.

RCT emulator code 200 may divide the subjects into two or more groups, based on the selected covariate, such that each of the resulting groups shares an enhanced uniformity in the probability of being assigned a same treatment in a hypothetical randomized controlled trial (406). In other words, RCT emulator code 200 may find and apply a division or split of the data subjects based on the value that moves each post-split group of data subjects toward a group that would have the most commonalities among the group such that each group has an enhanced uniformity in the probability to be assigned the same treatment in a randomized controlled trial. Step 406 is an example corresponding with step 306 of FIG. 3. RCT emulator code 200 may thereby select a division of the data subjects into groups such that the split most moves the data subjects toward groups that provide post hoc emulation of randomized controlled trials. For selecting the covariate with the highest bias measure in a multiple value split, RCT emulator code 200 may fit a piecewise-constant or a sigmoid function and split to multiple subpopulations according to the function fit. In some examples, RCT emulator code 200 may compute and determine the statistical significance of the split of the data subjects into the separate subtrees or children nodes of the respective node (408).

RCT emulator code 200 may recursively perform steps 402-408 on each of the subtrees arising from a respective split, or in other words, on each of the children nodes of a respective node (410). Step 410 is an example corresponding with step 308 of FIG. 3. RCT emulator code 200 may recursively repeat, for each of the groups, the applying a division of the subjects into two or more groups, until reaching a selected stopping criterion. RCT emulator code 200 may recursively repeat the division steps with respect to each group and branch of the causal tree that meets a selected stopping criterion, in various examples. In some examples, after RCT emulator code 200 has completely built the causal tree, RCT emulator code 200 may correct all p-values, such as by using a multiple hypothesis correction scheme, and prune the tree in accordance with the corrected p-values until all the leaves of the causal tree arise from a node with a significant p-value (412). In other examples, RCT emulator code 200 may be enabled to finish splitting the data subjects into children nodes that it finalizes as leaves of the causal tree such that the leaves already have a significant p-value, and no pruning is needed.

RCT emulator code 200 may select and use any of a number of stopping conditions for stopping dividing the subject data and finalizing assignments of divided groups of the subject data to correspond to nodes of the causal tree. In some examples, RCT emulator code 200 may use a stopping condition of reaching a node with minimal sample size. The minimal sample size may be in accordance with an argument defined by a user and received by RCT emulator code 200 as a user input. In some examples, RCT emulator code 200 may use a stopping condition of reaching a node with a strict positivity violation, e.g., all samples in the node belong to a single treatment group. In some examples, RCT emulator code 200 may use a stopping condition of reaching a node with a minimal bias measure value such as an ASMD value, e.g., all covariates are below an ASMD threshold or other bias measure threshold.

RCT emulator code 200 may thus stratify the data subjects into subpopulations that emulate randomized controlled trials. RCT emulator code 200 may thus also stratify the data subjects into subpopulations that emulate randomized controlled trials without requiring or performing causal inference correction methods, and without attempting to generate predictions of treatment assignments or outcomes, in various examples.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
determining, by a processor set, for each of a plurality of covariates in subject data on a plurality of subjects, a statistical bias measure;
selecting, by the processor set, one of the covariates based on the statistical bias measure;
dividing, by the processor set, the subjects into two or more groups, based on the selected covariate, such that each of the groups has an enhanced uniformity in a probability of being assigned a same treatment in a hypothetical randomized controlled trial; and
recursively repeating, by the processor set, for each respective group of the groups, the applying a division of the subjects into two or more groups, until reaching a selected stopping criterion for the respective group; and
deriving, by the processor set, observational results of one or more input factors of one or more of the groups.

2. The method of claim 1, wherein determining the bias measure comprises determining an absolute standardized mean difference (ASMD).

3. The method of claim 1, wherein selecting a covariate based on the bias measure comprises selecting a covariate determined to have the highest bias measure of any of the covariates.

4. The method of claim 1, wherein selecting a covariate based on the bias measure comprises selecting a covariate determined to have the higher bias measure than average for all of the covariates.

5. The method of claim 1, further comprising selecting a split value of the selected covariate,
wherein dividing the subjects into two or more groups based on the selected covariate comprises dividing the subjects into two or more groups based on the split value of the selected covariate, and
wherein selecting the split value of the selected covariate comprises:
determining a p-value for each of a plurality of threshold values of the selected covariate in the subject data; and
selecting one of the threshold values that has a minimal p-value as the split value.

6. The method of claim 5, wherein determining the p-value for each of the plurality of threshold values in the subject data comprises using Fisher's exact test.

7. The method of claim 5, wherein determining the p-value for each of the plurality of threshold values in the subject data comprises using a chi-squared test.

8. The method of claim 5, further comprising:
correcting the p-values, after reaching the selected stopping criterion; and
pruning a causal tree comprising the groups until all of a set of final groups of the causal tree result from splits having a statistically significant p-value.

9. The method of claim 1, wherein selecting a covariate based on the bias measure comprises fitting a piecewise-constant function, and
wherein dividing the subjects into two or more groups based on the selected covariate comprises dividing the subjects into multiple groups in accordance with the piecewise-constant function fit.

10. The method of claim 1, wherein selecting a covariate based on the bias measure comprises fitting a sigmoid function, and
wherein dividing the subjects into two or more groups based on the selected covariate comprises dividing the subjects into multiple groups in accordance with the sigmoid function fit.

11. The method of claim 1, further comprising determining a statistical significance of the dividing of the subjects into the two or more groups.

12. The method of claim 1, wherein the selected stopping criterion for the respective group comprises a minimum number of data subjects assigned to the respective group.

13. The method of claim 1, wherein the selected stopping criterion for the respective group comprises determining that there is no covariate and threshold value that has a p-value that passes a selected p-value threshold in the respective group.

14. The method of claim 1, wherein the selected stopping criterion for the respective group comprises determining that the respective group has a maximum bias measure under a minimal threshold of maximum bias measure.

15. A computer program product comprising one or more computer readable storage media having program instructions collectively stored on the one or more computer readable storage media, the program instructions executable to:
determine, for each of a plurality of covariates in subject data on a plurality of subjects, a statistical bias measure;
select one of the covariates based on the statistical bias measure;
divide the subjects into two or more groups, based on the selected covariate, such that each of the groups has an enhanced uniformity in a probability of being assigned a same treatment in a hypothetical randomized controlled trial;
recursively repeat, for each respective group of the groups, the applying a division of the subjects into two or more groups, until reaching a selected stopping criterion for the respective group; and
derive observational results of one or more input factors of one or more of the groups.

16. The computer program product of claim 15, wherein selecting a covariate based on the bias measure comprises selecting a covariate determined to have the highest bias measure of any of the covariates.

17. The computer program product of claim 15, further comprising selecting a split value of the selected covariate,
wherein dividing the subjects into two or more groups based on the selected covariate comprises dividing the subjects into two or more groups based on the split value of the selected covariate, and
wherein selecting the split value of the selected covariate comprises:
determining a p-value for each of a plurality of threshold values of the selected covariate in the subject data; and
selecting one of the threshold values that has a minimal p-value as the split value.

18. A system comprising:
a processor set, one or more computer readable storage media, and program instructions collectively stored on the one or more computer readable storage media, the program instructions executable to:
determine, for each of a plurality of covariates in subject data on a plurality of subjects, a statistical bias measure;
select one of the covariates based on the statistical bias measure;
divide the subjects into two or more groups, based on the selected covariate, such that each of the groups has an enhanced uniformity in a probability of being assigned a same treatment in a hypothetical randomized controlled trial;
recursively repeat, for each respective group of the groups, the applying a division of the subjects into two or more groups, until reaching a selected stopping criterion for the respective group; and
derive observational results of one or more input factors of one or more of the groups.

19. The system of claim 18, wherein selecting a covariate based on the bias measure comprises selecting a covariate determined to have the highest bias measure of any of the covariates.

20. The system of claim 18, further comprising selecting a split value of the selected covariate,
wherein dividing the subjects into two or more groups based on the selected covariate comprises dividing the subjects into two or more groups based on the split value of the selected covariate, and
wherein selecting the split value of the selected covariate comprises:
determining a p-value for each of a plurality of threshold values of the selected covariate in the subject data; and
selecting one of the threshold values that has a minimal p-value as the split value.
